(19) United States
(12) Patent Application Publication
(10) Pub. No.: US 2014/0075493 A1
(43) Pub. Date: Mar. 13, 2014

(54) SYSTEM AND METHOD FOR LOCATION-BASED PROTECTION OF MOBILE DATA

(71) Applicants: Parameshwaran Krishnan, Basking Ridge, NJ (US); Navjot Singh, Denville, NJ (US)

(72) Inventors: Parameshwaran Krishnan, Basking Ridge, NJ (US); Navjot Singh, Denville, NJ (US)

(73) Assignee: Avaya, Inc., Basking Ridge, NJ (US)

(21) Appl. No.: 13/611,022

(22) Filed: Sep. 12, 2012

(51) Int. Cl. G06F 21/00

(52) U.S. Cl. 726/1

(57) ABSTRACT

System and method to provide location-based levels of data protection, the method including: receiving, by a receiver, login credentials of a user of a mobile device; authenticating, by use of a policy server, a credentials-based level of data access as configured by a policy; retrieving, by a geo-location module, a location of the mobile device; determining, by use of the policy server, a location-based level of data access as configured by the policy; and granting sensitive data access based upon a more restrictive limitation of the credentials-based level of data access and the location-based level of data access.

### BACKGROUND

1. Technical Field

Disclosed embodiments generally relate to data protection, and, in particular, to providing an adjustable level of protection of data in mobile devices based upon the location of the device and/or a password.

2. Description of Related Art

Enterprise data in mobile devices is a cause of concern for most corporations because the data in mobile devices is inherently at risk. This data can be compromised by theft of the device or users being coerced to provide access to the device. There are also concerns when travelling to certain countries where local laws and regulations may put access to the data at risk. Many users are also unaware of the level of safety of their location and the laws of the country that they are operating in. The issue is more important with the increase in Bring Your Own Device (“BYOD”), which relies upon users to supply their own mobile communication and/or computing devices. It is more difficult to implement and enforce a cohesive security policy under BYOD because of the diverse hardware devices and lack of centralized control and accountability. The different types of data in the mobile devices also have different levels of sensitivity and usage characteristics, which may inherently allow for different levels of security, else placing the highest level of security on all data.

Data may be encrypted, but the encryption password is usually known to the user and therefore is subject to compromise. The devices can also be password protected, but users in general are notorious for picking passwords that may be easy to guess. Smart-card and two-factor authentications are sometimes used, but these techniques require extra security fobs, authentication steps, or the like, which may tend to discourage their usage by users as the techniques become more intrusive. Enterprises can control access based on mobile data status and there are techniques available for dealing with administrators resetting password of encrypted storage if a user forgets their password, however these techniques may not be available if a communication link with a central administrator is unavailable or unreliable.

Furthermore, users may reveal passwords either unknowingly (e.g., because spyware has been installed on their mobile device), or the interactions may be sniffed, or they have been tricked or coerced to provide passwords or other credentials to get access to the data. Encryption schemes do not automatically tag sensitive data and store the sensitive data in different or segregated memory. Some applications may function properly only when connected to the network (e.g., telecommunication applications), but the applications do not fully employ data protection features available through the network (e.g., cloud services). Even with cloud-based services, there may exist local copies (e.g., user-saved or cached) of data which may be subject to compromise.

### SUMMARY

An embodiment in accordance with the present invention may include a method to provide location-based levels of data protection, the method including: receiving, by a receiver, login credentials of a user of a mobile device; authenticating, by use of a policy server, a credentials-based level of data access as configured by a policy; retrieving, by a geo-location module, a location of the mobile device; determining, by use of the policy server, a location-based level of data access as configured by the policy; and granting sensitive data access based upon a more restrictive limitation of the credentials-based level of data access and the location-based level of data access.

An embodiment in accordance with the present invention may include a system to provide location-based levels of data protection, the system including: a receiver configured to receive login credentials of a user of a mobile device; a geo-location module configured to retrieve a location of the mobile device; a policy server configured to perform the steps of: authenticating a credentials-based level of data access as configured by a policy; and determining a location-based level of data access as configured by the policy; and a processor configured to grant sensitive data access based upon a more restrictive limitation of the credentials-based level of data access and the location-based level of data access.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings wherein like reference numerals in the various figures are utilized to designate like components, and wherein:

FIG. 1 illustrates a functional diagram of a system according to an embodiment of the present invention;

FIG. 2 illustrates a pictorial diagram of the system of FIG. 1;

FIG. 3 illustrates an exemplary flow diagram according to one or more embodiments of the present invention; and

FIG. 4 illustrates an exemplary method for updating security patches, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

A policy may be understood as rules that guide the providing of goods and/or services. For example, a security policy may include the rules (e.g., circumstances and methods) under which access to electronic data is allowed or not allowed (i.e., data entitlement). A policy may change or adapt over time as experience is gained, new circumstances arise, or the needs of an organization using the policy changes. An automated system may be used to manage (e.g., change and control) and to enforce a security policy quickly, consistently and efficiently. An automated system may be used to provide some or all of these benefits in real time, for example by communicating with a central authority (e.g., policy server) or database, or by local dissemination of the policy and decision-making.

Embodiments in accordance with the present invention allow a location-based policy for data protection, data entitlement and key management, with support for plausible deniability, all administered in a centralized way, thereby reducing the burden on the user for data protection on mobile devices. If communication with the central authority is unable to be established, or is disrupted, lost, etc., then data access may default to granting access only to non-sensitive data. Embodiments also provide greater control of sensitive data to enterprises.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, “user” and “participant” may be used interchangeably, unless a distinction is clearly intended, either explicitly or from the surrounding context.

Disclosed embodiments are illustrated below in conjunction with an exemplary communication system. Although well suited for use with, for example, a system using a server(s) and/or database(s), the disclosure is not limited to use with any particular type of communication system or configuration of system elements.

The exemplary systems and methods of this disclosure will also be described in relation to application software, modules, and associated application hardware. However, to avoid unnecessarily obscuring the present disclosure, the following description omits well-known structures, components and devices that may be shown in block diagram form, are well known, or are otherwise summarized.

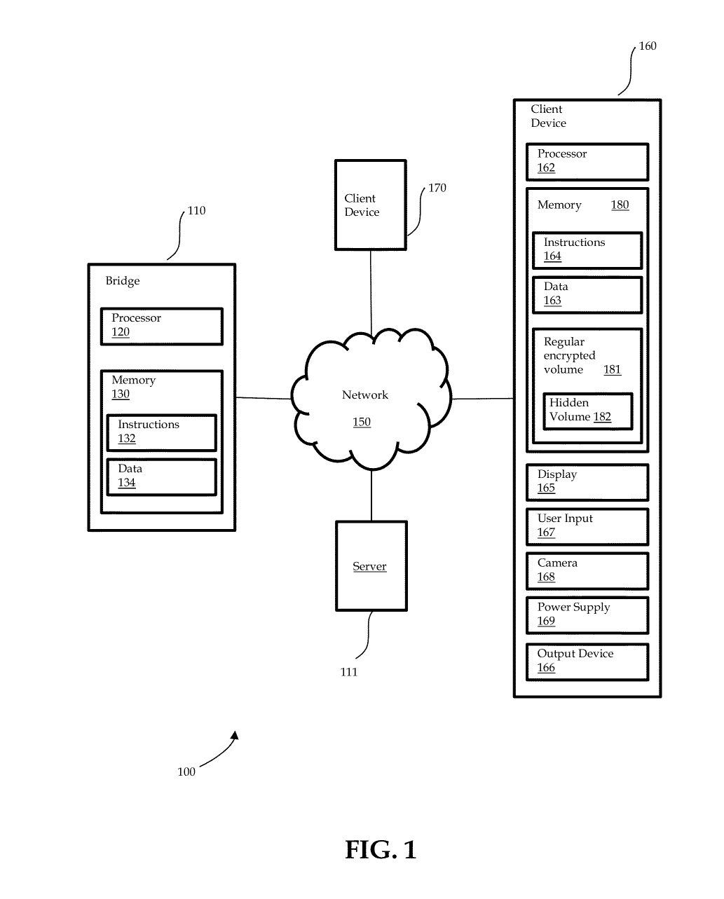

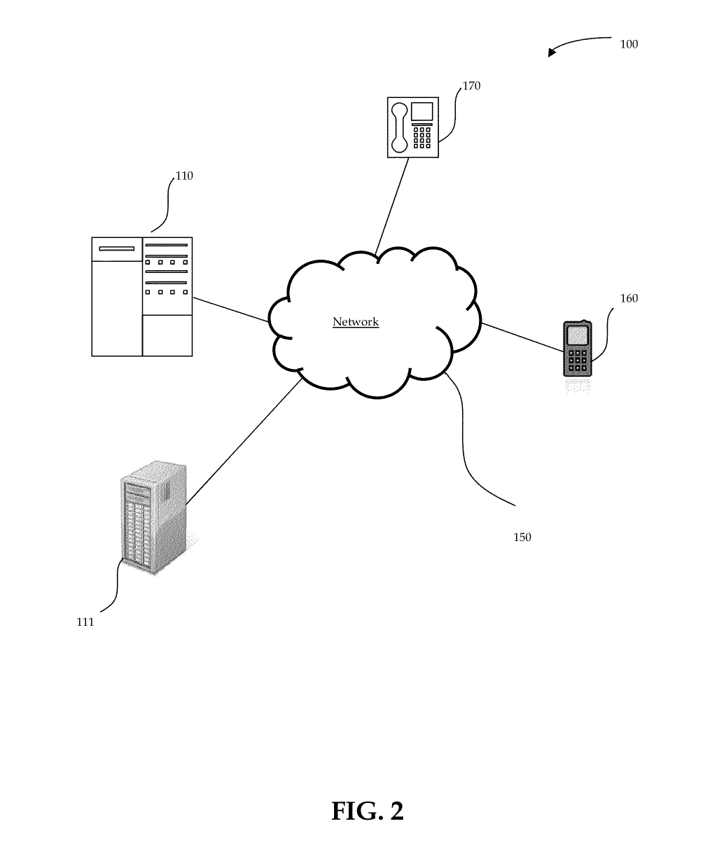

As shown in FIGS. 1-2, a system 100 in accordance with one aspect of the present technology includes server 110 containing a processor 120, memory 130 and other components typically present in a communication device.

The server 110 may comprise one or more telecommunications devices that can provide data, video and/or audio services, such as, for example, a video server, a Private Branch Exchange (PBX), a switch, a web server, a security server, a key management server, or a network server or any other device capable of communicating data, bridging/mixing audio and/or video streams. Furthermore, server 110 may be at one node of a network 150 and may be capable of directly and indirectly receiving data from and sending data to other nodes of the network. For example, server 110 may be capable of receiving data from client device 160 via network 150 such that server 110 uses network 150 to transmit and display information to a user on display 165 of client device 170. Server 110 may also be operable to receive data from client device 160 via network 150 and transmit the data to one or more output devices such as, for example, speakers or one or more displays that are associated with server 110. Similarly, server 110 may, for example, comprise a web server that is capable of receiving data from a server 111 such that server 110 uses network 150 to transmit information to server 111. Differences in capability between different media devices (e.g., a camera whose resolution does not match a resolution of a viewing device) may be handled by use of techniques such as clipping, interpolation, decimation, codec conversions, etc.

Server 110 may also comprise a plurality of devices that exchange information with different nodes of a network for the purpose of receiving, processing and transmitting data to client devices. In this instance, the client devices will typically still be at different nodes of the network than any of the devices comprising server 110. Although server 110 is shown external to network 150, server 110 may be part of network 150.

System 100 may include a policy server that manages keys, document security level and can influence how the data is organized on client device 160. The policy server may also include a component that monitors the location of client device 160. The policy server may be integrated within server 110, or may be implemented as a separate server (not shown in FIG. 1) in communication contact with server 110 and client device 160 through network 150.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, solid-state drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as any commercially available CPU. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor, a computer or a memory will be understood to include references to a collection of processors, computers or memories that may or may not operate in parallel.

Network 150 may be any telecommunications network such as, for example, the Internet, a Wide Area Network (WAN), a Local Area Network (LAN), the Public Switched Telephone Network (PSTN), Bluetooth, Near Field Communication (NFC), WiFi, a cellular network, and an Integrated Digital Services Network (ISDN). Furthermore, network 150 may include one or more telecommunications networks with various configurations and may use various protocols such as, for example, VoIP, TCP/IP, proprietary protocols, instant messaging, HTTP and SMTP, and various combinations of the foregoing. Although only a few computers are depicted in FIGS. 1-2, it should be appreciated that a typical system can include a large number of connected computers.

Each client device 160 or 170 may be any type of telecommunications device that can output a video and/or audio stream, such as, for example, a telephone, a cellular telephone, a Personal Computer (PC), a Personal Digital Assistant (PDA), a tablet computer, a monitor, a television, or a conference room video system. Furthermore, each client device may be configured similarly to server 110, as described above, and may include various components such as, for example, a central processing unit (CPU) 162, memory 180 (e.g., RAM and internal hard drives) storing data 163 and instructions 164, an electronic display 165 (e.g., a monitor having a screen, a touch-screen, a projector, a television, a computer printer or any other electrical device that is operable to display information), output devices 166 (e.g., speaker, headset, headset connector), user input 167 (e.g., a mouse, keyboard, touch-screen or microphone), a camera 168, a power supply 169 (e.g., battery, AC adaptor connector, solar cell, or other power source), a network interface device, and all of the components used for connecting these elements to one another. Although shown as a single device, client devices 160 or 170 may be distributed between multiple devices. For example, client device 160 may be distributed between a telephone and a personal computer.

Memory 180 may further include at least a portion that is designated as a regular encrypted volume 181. Regular encrypted volume 181 stores encrypted data. Regular encrypted volume 181 may further include a hidden volume 182 that stores data that is hidden in addition to being encrypted. A portion of data 163 may be stored within regular encrypted volume 181 and/or hidden volume 182.

In addition to the operations described below and illustrated in the figures, various operations in accordance with aspects of the present technology will now be described. It should also be understood that the following operations do not have to be performed in the precise order described below. Rather, various steps can be handled in a different order or simultaneously. Steps may also be removed or added.

Embodiments in accordance with the present invention may be used for connected applications (e.g., telecommunication applications) with a “bring your own device” (BYOD) mode of operation. The BYOD device may correspond to client device 160. Embodiments begin from a starting point of assuming that the client device 160 includes encrypted storage, and that data in the device is stored in the encrypted storage. Alternatively, an application program may have been installed on the client device 160 by an enterprise, and the application program had created the encrypted storage. Data that is to be stored on client device 160 may be tagged, e.g., by use of metadata and a policy engine operating on server 110 or other enterprise server, with the level of security protection needed on the client device 160 when the data is retrieved.

In other embodiments in accordance with the present invention, if data to be securely stored is generated by server 110, the data may be pre-tagged in server 110 with metadata of the data, e.g., by use of content analysis techniques in server 110. If the data is generated locally (e.g., local email), the user may be prompted to indicate whether the local data is personal data or enterprise data. The user may then be prompted for a security level of the data. Higher security levels may be available for enterprise data than for personal data. Alternatively, a cloud-based or enterprise-based service may be provided keywords or a content digest of the data, and be configured to analyze a sensitivity level of the data and provide an appropriate tag.

A known mode of operating an encrypted data store may include steps of authenticating a user with a server (e.g., an enterprise server), and supplying a decryption key for the encrypted storage. However, in at least some embodiments in accordance with the present invention, the policy and keys are maintained in an enterprise server. Whether a decryption key is presented to a client device 160 upon request, and which decryption key is presented if the request is allowed, may depend on various factors, such as the location of the user (e.g., which country they are in), a time of access, behavioral deviations from the norm, status of the device, status of its software, and so forth. For example, a traveler to a country that is deemed to be dangerous at least from an industrial espionage perspective may have a request for a decryption key denied based on GPS location, IP address, service provider identity, or other indicia of location.

Behavioral deviations from the norm look for patterns of behavior that are not typical or normal, either for this user or users like this user. For example, it is likely that a user usually follow a specific login process such as accessing certain application to access the data. A change by the user in that behavior will indicate a behavioral deviation. Other examples of behavioral deviations may include attempted access from multiple devices, repeated logins, requested access to a large set of files, etc., if any of those behaviors are not normal for this user or users like him.

In some embodiments, a user may authenticate using one of several passwords. Multiple passwords may be useful, for example, when differing levels of security are needed, or when there exist subsets of data that are non-overlapping in some sense. An example of non-overlapping subsets of data may be if users of a first subset of data do not need to know a second subset of data, and users of the second subset of data do not need to know the first subset of data. In that situation, the first and second subsets of data may be protected by different passwords.

In another embodiment, the user may have multiple passwords to designate a respective state of usage. For example, a normal password may be used to designate normal behavior and a distress password may be used to indicate that the user is in distress. If the distress password is used, the resulting distress decryption key that is provided will not decrypt all information in the client device 160, e.g., sensitive information may remain hidden and encrypted. The distress decryption key may decrypt a portion of the encrypted storage in order to provide plausible deniability. The software may at substantially the same time covertly delete (i.e., delete without notification or verification) certain sensitive data when the distress password is used. If a communication channel to the enterprise is available, then an encrypted tunnel may be established between client device 160 and the enterprise, in order to back up data from client device 160 before that data is deleted.

In another embodiment, a designation of normal condition or distress condition may be made by usage of a predetermined user name. In some embodiments, the designation may be made by selection of a user name from among two or more different user names that are tied together using a single password (e.g., username-1 may indicate a normal user, but username-2 may indicate a distressed user, wherein both username-1 and username-2 have the same password). In another embodiment, a predetermined number of consecutive failed login attempts may indicate a distress condition. In another embodiment, if one or more verification questions are asked, alternative answers may indicate regular and distress conditions.

In embodiments in accordance with the present invention, the user of client device 160 may communicate with an enterprise server to obtain one or more enterprise-generated decryption keys. At least some of the decryption keys may decrypt the hidden volume, and may only be provided based on the context of the request for data access. In another embodiment, the decryption keys may be locally-generated using one of several known techniques such as public key cryptography standard #5 (“PKCS#5”), which supports password-based encryption. Locally-generated and enterprise-generated decryption key generation techniques may be used simultaneously. For example, some portions of the encrypted storage may use the locally-generated decryption key, and other portions (e.g., a hidden volume discussed below) may use the enterprise-generated decryption key.

Embodiments in accordance with the present invention may also include the layout of the encrypted memory, using multiple keys to support plausible deniability. Plausible deniability may be provided using “hidden volumes” or similar techniques, such that separate portions of memory storage are encrypted with different keys and a metadata is maintained elsewhere. The metadata may include user-clearance level, data sensitivity level, geographic limitations of the data access and/or data storage, where the decryption keys may be stored, and so forth. The metadata may be stored on the enterprise server and may be sent along with the files to client device 160 so that it can store the metadata in an appropriate encrypted store. Data being retrieved from an enterprise may be automatically tagged with metadata for a sensitivity level and placed in the appropriate volume of the encrypted storage in client device 160, based on the sensitivity level.

For example, when data from the enterprise is requested or accessed by client device 160 (e.g., a mobile device), a geographic location of client device 160 may also be transmitted to the enterprise. The enterprise, in consultation with policies that include the approved levels of data access and encryption for geographic regions, would then automatically provide the client device 160 with approved data. The data may be on client device 160 on not on client device 160 (e.g., in the enterprise), or a combination thereof. The data may be tagged with sensitivity level and may be stored separately based on sensitivity level. Based on the policies that may include factors like geographic location of access, sensitive data may or may not be provided to client device 160. In some situations (e.g., a distress situation), fake data may be generated and provided to client device 160. For access to data on client device 160, the keys for decrypting the storage corresponding to sensitive data may or may not be provided to client device 160. The enterprise may also tag the data with metadata (e.g., in storage, during transit, based on clearance level needed for access, etc.) for sensitivity levels and the metadata tags may be used by mobile device software for placement in appropriate encrypted storage. The data may also be tagged with metadata to include respective expiration dates for use by an automatic deletion process.

For example, consider two classes of data: sensitive and non-sensitive. Both the sensitive data and the non-sensitive data will be protected by encryption, but the sensitive data is more critical and will be additionally protected by use of cloaking, i.e., hiding the data. The encrypted storage is divided into two parts: a regular encrypted volume (“REV”) and a hidden volume inside the REV. The hidden volume may not be visible to anybody even if the REV has been decrypted. This encrypted+hidden volume combination is automatically created when sensitive data is present. Files in the enterprise are tagged for sensitivity levels and stored in the appropriate volume. An interaction with the enterprise may begin when the user provides login credentials to access the data from the enterprise. The enterprise authenticates the users and checks the user location and security access level, etc. Based on this interaction, the enterprise policy server provides or denies the access to the encryption keys from the key store. If the keys are retrieved by interaction with the enterprise, the key for the sensitive volume may be withheld from the user based on policy. For example, the enterprise policy server after checking with the policy may grant or deny access based on the location from where the user is logging in, or based on the security clearance level. If a locally generated key is used, the user may remember the key for the REV volume. If they need to decrypt the hidden volume, they could either: (i) remember another locally generated key; (ii) store the locally generated key inside multiple files and remember the files—in this option, all or portions of the locally generated key may be stored in sections of the files or portions thereof. The information as to what parts of the files are used for this purpose may be stored at the enterprise policy server along with the decryption keys; and/or (iii) store this locally generated key in the cloud and retrieve it as needed.

Although multiple keys may be used to encrypt the data storage, the user need not remember the multiple keys. The keys may be stored in the enterprise server and retrieved automatically using a public/private key infrastructure. The user may have to remember more than one password (e.g., one password to unlock local storage and another to authenticate with the enterprise server and perhaps an additional distress password), and the policy server takes care of storing and providing the keys based upon the perceived threat, checking for access levels, location of devices, and so forth.

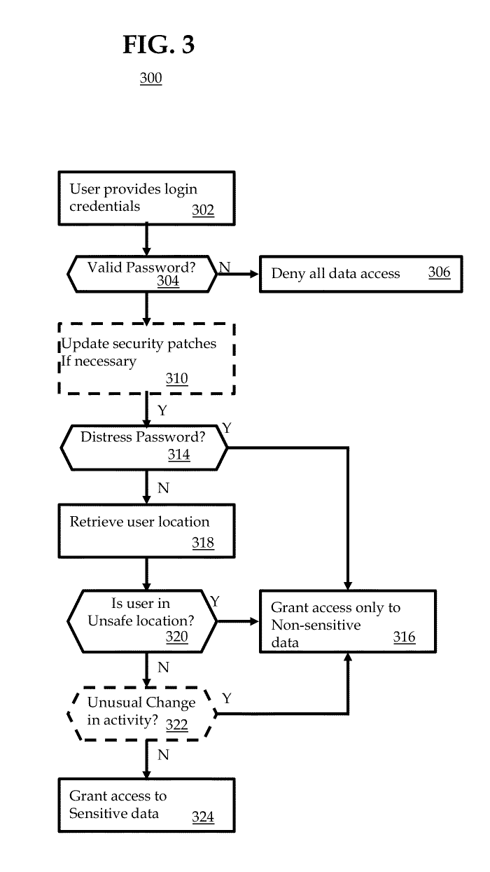

FIG. 3 illustrates an exemplary method 300 for providing location-based access to encrypted data by client device 160, in accordance with an embodiment of the present invention. Method 300 assumes that the encrypted data has already been stored in a memory according to whether it is sensitive data or non-sensitive data.

At step 302, a user of client device 160 provides access credentials such as a username, a password, an answer to a challenge question, and so forth. The credentials may be received by a receiver of the mobile device. Authentication of the access credentials may occur locally in client device 160, and/or the access credentials may be provided to, and received by, a server for remote authentication. Biometric access credentials may also be used. For example, a user may provide an index fingerprint to access only non-sensitive data, but a thumbprint to access sensitive data. Or, a user may provide the left retina to access only non-sensitive data, but the right retina to access sensitive data. Gesture-based access may also be provided by use of video capture and motion analysis techniques, such that one gesture (e.g., a substantially horizontal motion) grants access only to non-sensitive data, but another gesture (e.g., a substantially vertical motion) grants access sensitive data. Other types of gestures (or lack of gestures) may be used if they are distinguishable by the video analysis techniques.

At step 304, the access credentials provided by the user are authenticated to determine validity. If the access credentials are not valid at all, then control of process 300 passes to step 306, at which the user of the mobile device is denied access to all data. If the access credentials are valid, then control of process 300 may pass to optional step 310 or, if optional step 310 is not to be performed, directly to step 314.

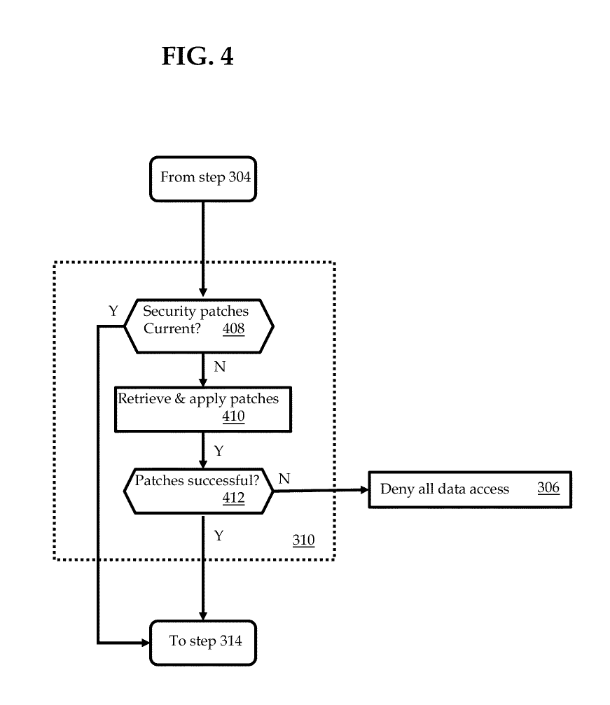

At optional step 310, security patches are updated if necessary. Optional step 310 is described more fully with respect to FIG. 4. If optional step 310 completes successfully, control of process 300 transfers to step 314.

At step 314, the access credentials provided by the user are further authenticated, to authenticate the level of data access to be granted to the user. For example, the access credentials may be examined to determine whether they correspond to a distress password or a non-distress password. If the access credentials correspond to a distress password or other indicator of distress, then control of method 300 transfers to step 306. If the access credentials correspond to a non-distress password, then control of method 300 transfers to step 318.

At step 316, the user is granted access only to non-sensitive data.

At step 318, the user's location is retrieved. Location may be determined by a geo-location module in a variety of ways, such as GPS coordinates, IP domain, or other automatic methods. Location methods that depend upon user input may be unreliable if a malicious user is trying to spoof the mobile device location. Location determination should be specific enough to identify the nation or jurisdiction in which the mobile device is located. For instance, if a foreign country has both safe provinces and unsafe provinces, then location determination should be able to resolve between the provinces. Safety or unsafety may be determined with respect to the safety of the data, the device, and/or the user. For example, data may be unsafe if it is at risk of being wiretapped, sniffed from wireless transmissions, or otherwise compromised. The device may be unsafe if it or a component (e.g., memory card) is at risk of physical theft, copying or tampering. The user may be unsafe if the user is at risk of kidnapping, intimidation, trickery, surveillance, coercion to reveal passwords, and the like.

At step 320, the location information may be compared to a list of unsafe locations. If the location of the mobile device is unsafe, then control of method 300 passes to step 316, otherwise control of method 300 passes to step 322. Alternatively, the location information may be compared to a list of safe locations. If the location of the mobile device is not known to be safe, then control of method 300 passes to step 316, otherwise control of method 300 passes to step 322.

At optional step 322, additional tests may be performed to determine whether the user of the mobile device is in distress. For example, a pattern of user activity on the mobile device may be compared to historical patterns of usage for either this user or similar users in the geographic region, such as what applications are accessed, how much activity takes place, sources and destinations of communications, and so forth. Historical patterns may be recorded in the policy server. If there are unusual changes, control of method 300 may transfer to step 316 in order to grant the user of the mobile device access only to non-sensitive data. If there is no indication that the user is in distress, then control of method 300 passes to step 324.

At step 324, the user is granted access to both sensitive and non-sensitive data. Access to sensitive data therefore depends upon passing all tests directed to narrowing the data access, i.e., passing all tests directed to verifying that the user is allowed to access sensitive data, and failing all tests directed to determining whether the user should be restricted only to non-sensitive data.

FIG. 4 illustrates an exemplary optional method 310 for updating security patches, in accordance with an embodiment of the present invention. Method 310 may be performed to make sure that client device 160 is patched and updated according to the enterprise security policy. If client device 160 is not up to date either point it to the security policy server for upgrade or deny access.

As illustrated, control of method 310 enters from step 304 of method 300. First within method 310, step 408 is performed to query whether the security status of client device 160 is up-to-date with the security status of the security policy server. Security status may include databases, signatures, processes, and the like that are used to provide security. The query may involve communicating the security status of client device 160 to the security policy server for comparison at the security policy server, or communicating the up-to-date security status of the security policy server to client device 160 for comparison at client device 160. If the security is up-to-date, optional method 310 ends and control may return to step 314 of method 300.

If the security is not up-to-date, method 310 may pass to step 410, at which security patches may be retrieved from the security policy server and applied to client device 160. Control of method 310 then passes to step 412.

At step 412, a test is performed to verify whether the update patches were applied successfully. If the update was not successful, then control of method 310 may pass to step 306. If the update was successfully applied, then control of method 310 exits and may transfer to step 314 of method 300.

As these and other variations and combinations of the features discussed above can be utilized without departing from the disclosure as defined by the claims, the foregoing description of exemplary embodiments should be taken by way of illustration rather than by way of limitation of the invention as defined by the claims. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context. Rather, the examples are intended to illustrate only some of many possible aspects.

Embodiments of the present invention include a system having one or more processing units coupled to one or more memories. The one or more memories may be configured to store software that, when executed by the one or more processing unit, allows one or more callers to be authenticated by responding to a challenge request, at least by use of processes described herein, including at least in FIG. 3, and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

Moreover, the claims should not be read as limited to the described order or elements unless stated to that effect. In addition, use of the term “means” in any claim is intended to invoke 35 U.S.C. §112, ¶6, and any claim without the word “means” is not so intended.

We claim:

1. A method to provide location-based levels of data protection, comprising:
receiving, by a receiver, login credentials of a user of a mobile device;
authenticating, by use of a policy server, a credentials-based level of data access as configured by a policy;
retrieving, by a geo-location module, a location of the mobile device;
determining, by use of the policy server, a location-based level of data access as configured by the policy; and
granting sensitive data access based upon a more restrictive limitation of the credentials-based level of data access and the location-based level of data access.

2. The method of claim 1 wherein the sensitive data comprises a metadata of the sensitive data.

3. The method of claim 1, further comprising: pre-tagging the sensitive data by use of a content analysis technique.

4. The method of claim 3 wherein the content analysis technique comprises a service configured to analyze at least one of a keyword and a content digest of the sensitive data.

5. The method of claim 1 wherein the credentials-based level of data access comprises a plurality of credentials usable by a single user, each credential indicative of a respective state of usage.

6. The method of claim 1, further comprising: covertly deleting predetermined sensitive data on the mobile device if a distress credential is used.

7. The method of claim 5 wherein the plurality of credentials comprises a plurality of login names.

8. The method of claim 5 wherein the plurality of credentials comprises a plurality of biometric access credentials.

9. The method of claim 5 wherein the plurality of credentials comprises a plurality of gesture-based access credentials.

10. The method of claim 1, further comprising: determining the location-based level of data access from the geographic location of the mobile device.

11. The method of claim 1 further comprising: providing a lower level of data access if there is no communication with the policy server.

12. The method of claim 1, further comprising determining a level of data access based upon historical patterns of usage, as configured by the policy.

13. The method of claim 1, wherein the step of granting sensitive data access comprises granting sensitive data access to data stored on the mobile device.

14. The method of claim 1, wherein the step of granting sensitive data access comprises granting sensitive data access to data not stored on the mobile device.

15. A system to provide location-based levels of data protection, comprising:
a receiver configured to receive login credentials of a user of a mobile device;
a geo-location module configured to retrieve a location of the mobile device;
a policy server configured to perform the steps of:
authenticating a credentials-based level of data access as configured by a policy; and
determining a location-based level of data access as configured by the policy; and
a processor configured to grant sensitive data access based upon a more restrictive limitation of the credentials-based level of data access and the location-based level of data access.

16. The system of claim 15, further comprising: pre-tagging the sensitive data by use of a content analysis technique, wherein the content analysis technique comprises a service configured to analyze at least one of a keyword and a content digest of the sensitive data.

17. The system of claim 15 wherein the credentials-based level of data access comprises a plurality of credentials usable by a single user, each credential indicative of a respective state of usage.

18. The system of claim 15, further comprising a covert module configured to covertly delete predetermined sensitive data on the mobile device if a distress credential is used.

19. The system of claim 17 wherein the plurality of credential comprises a plurality credentials selected from the group consisting of login names, biometric access credentials, and gestures.

20. The system of claim 15, further comprising a processor that is configured to provide a lower level of data access if there is no communication with the policy server.

21. The system of claim 15, further comprising a processor that is configured to determine a level of data access based upon historical patterns of usage, as configured by the policy.
